(19) United States
(12) Patent Application Publication
(10) Pub. No.: US 2014/0317908 A1
(43) Pub. Date: Oct. 30, 2014

(54) METHOD FOR MANUFACTURING LAMINATED IRON CORE AND SHAPE OF SCRAP PRODUCED THEREBY

(71) Applicant: Mitsui High-tec Inc., Kitakyushu-shi, Fukuoka (JP)

(72) Inventors: Kazuhiko Umeda, Kitakyushu-shi (JP); Masahiro Izumi, Kitakyushu-shi (JP)

(73) Assignee: MITSUI HIGH-TEC INC., Kitakyushu-shi, Fukuoka (JP)

(21) Appl. No.: 14/360,154

(22) PCT Filed: Nov. 13, 2012
(86) PCT No.: PCT/JP2012/079389

§ 371 Date: May 22, 2014

(30) Foreign Application Priority Data
Dec. 5, 2011 (JP) 2011-266031

(51) Int. Cl. H02K 15/02; B21D 28/02

(52) U.S. Cl. CPC H02K 15/02; B21D 28/02
USPC 29/598; 29/609; 72/338; 83/13

(57) ABSTRACT

A method for manufacturing a laminated iron core by press punching a thin strip material to manufacture a motor core, comprising, before punching out a scrap 10 of an iron core piece 11 for the motor core, forming a plurality of partition holes 15 in the scrap 10 to divide the scrap 10 into areas 20, each of the partition holes 15 being connected at one end thereof with a peripheral portion 14 of the scrap 10 through a first connecting portion 17. The method further comprises forming a central hole 12, which is connected with the partition holes 15 through second connecting portions 18, at a central portion of the scrap 10. Accordingly, provided are the method for manufacturing a laminated iron core without causing scrap pulling when punching out and laminating the thin iron core pieces 11 and the shape of the scraps formed thereby.

### TECHNICAL FIELD

The present invention relates to a method for manufacturing a laminated iron core, and particularly to a method for manufacturing a laminated iron core (motor core) without causing uplift of scraps (scrap pulling) when thin, large diameter iron core pieces (core pieces) are stamped out and stacked, and also to a shape of scraps produced by the method.

### BACKGROUND ART

In recent years, to reduce burdens on the environment, the number of vehicles using motors as main power such as electric vehicles and hybrid vehicles has been rapidly increasing. Along with the increase, the production volume of motor cores (laminated iron cores) which are main components of the motors has also been increasing. In the case of motor cores used as power motors for vehicles, even for general passenger cars, the motor cores are being manufactured to have a diameter of more than 300 mm and a plate thickness of 0.50 mm or less. Increasing the diameter of the motor core and decreasing the plate thickness require a higher level of technology in stamping and stacking operations and the current technology alone is insufficient. In particular, in the manufacture of stator core pieces having a large diameter space inside, there is a strong need for measures against scrap pulling.

A manufacturing process of a stator core formed by lamination of stator core pieces includes, for example, as illustrated in FIG. 4: a station “a” where a central circular hole 51 is formed by successively feeding thin strip materials 50 to a die apparatus, stations “b” and “c” where slots 53 for forming side ends of magnetic pole portions 52 are punched out; a station “d” where caulking portions 54 are formed; and a station “e” where a manufactured stator core piece 56 is punched out and dropped into a die. Consequently, an area of the circular hole 51 becomes a scrap piece 57 and the above-mentioned problem of scrap pulling occurs.

Scrap pulling commonly occurs due to adhesion between a punch and a scrap caused by reduced pressure or oil, pressure bonding of the material, etc. The conventional art used as measures against scrap pulling includes transformation of the upper surface of the punch, taper-shaping the lateral face of the die, change in the shape of the die, a kicker pin, air-blow, a vacuum, etc. (See Patent Literatures 1-3.)

### CITATION LIST

### Patent Literature

Patent Literature 1: Japanese Unexamined Utility Model Application Publication No. H06-029717

Patent Literature 2: Japanese Examined Utility Model Application Publication No. Sho 62-017133

Patent Literature 3: Japanese Unexamined Patent Application Publication No. H06-142785

### SUMMARY OF INVENTION

### Technical Problem

However, as the diameter of the motor core increases while the plate thickness decreases, in the case of a seamless one-piece stator core piece (stator core piece) 60 as illustrated in FIG. 5(A), a scrap piece (scrap) 61 punched out from the inside of the stator core piece 60 might have a diameter of 200 mm or more and a plate thickness of 0.30 mm or less. Even in the case of the scrap piece 61 having such a diameter, if it has a typical plate thickness of core pieces used for other common motors (e.g., about 0.3 to 0.5 mm), the punched out scrap piece 61 is firmly retained by the internal circumferential surfaces of a die 63 and a squeeze ring 64 as illustrated in FIG. 5(B) because of high rigidity (strength) of the material. However, in the case of the scrap piece 61 as illustrated in FIG. 5(C) having a small plate thickness (specifically 0.3 mm or less), it is retained in an undulated state by lateral pressure of the inner surface of the die due to low rigidity of the material. At this time, scrap pulling occurs, that is, the scrap piece 61 protrudes out of the upper surface of the die due to springback, thereby disadvantageously causing scratches or damages to a die 65 and the stator core piece 60.

The preset invention has been made in view of the above circumstances, and an object thereof is to provide a method for manufacturing a laminated iron core without causing scrap pulling when thin iron core pieces (core pieces) are stamped out and stacked, and also to provide a shape of scraps produced thereby.

### Solution to Problem

To achieve the above object, according to a first invention, there is provided a method for manufacturing a laminated iron core by press punching a thin strip material to manufacture a motor core, the method comprising: before punching out a scrap of an iron core piece for the motor core, forming a plurality of partition holes in the scrap to divide the scrap into a plurality of areas, each of the partition holes being connected at one end thereof with a peripheral portion of the scrap through a first narrow connecting portion.

According to a second invention, the method for manufacturing a laminated iron core of the first invention further comprises forming a central hole at a central portion of the scrap, the central hole being connected with an opposite end of each of the partition holes through a second narrow connecting portion.

According to a third invention, in the methods for manufacturing a laminated iron core of the first and second inventions, the areas divided by the partition holes are provided with caulking portions for allowing a plurality of the scraps to be stacked and fixed.

According to a fourth invention, in the methods for manufacturing a laminated iron core of the first to third inventions, the scrap has a circular shape and the plurality of the partition holes are formed at equal angles along a radial direction of the scrap.

According to a fifth invention, there is provided a shape of a scrap produced during manufacture of a motor core by press punching a thin strip material, comprising a plurality of partition holes for dividing the scrap into a plurality of areas, each of the partition holes being connected at one end thereof with a peripheral portion of the scrap through a first narrow connecting portion.

According to a sixth invention, in the shape of the scrap of the fifth invention, a central hole is formed at a central portion of the scrap, and an opposite end of each of the partition holes is connected with the central hole through a second narrow connecting portion.

According to a seventh invention, in the shapes of the scrap of the fifth and sixth inventions, the areas divided by the partition holes are provided with caulking portions for allowing a plurality of the scraps to be stacked and fixed.

According to an eighth invention, in the shape of the scrap of the seventh invention, the caulking portions are formed in proximity to the peripheral portion of the scrap.

According to a ninth invention, in the shapes of the scrap of the fifth to eighth inventions, the scrap has a circular shape with a diameter of 200 mm or more and a thickness of 0.3 mm or less.

According to a tenth invention, in the shapes of the scrap of the fifth to ninth inventions, the scrap is equally divided into the plurality of the areas by the partition holes.

According to an eleventh invention, in the shapes of the scrap of the fifth to tenth inventions, the number of the partition holes is at least three.

According to a twelfth invention, in the shapes of the scrap of the fifth to eleventh inventions, a width of the first narrow connecting portions is between 1 and 7 times a plate thickness of the scrap.

According to a thirteenth invention, in the shapes of the scrap of the fifth to twelfth inventions, a width of the partition holes is 3 times or more the width of the first narrow connecting portions.

### Advantageous Effects of Invention

The method for manufacturing a laminated iron core according to the present invention and the shape of scraps punched out by the method provide the following operational advantages.
(1) By forming the plurality of the partition holes in the scrap to divide the scrap into a plurality of areas and forming the first narrow connecting portions between one end of each partition hole and the peripheral portion of the scrap, undulation is absorbed by the first narrow connecting portions and the partition holes, thereby preventing the springback and allowing large-diameter thin plates to be stamped out.
(2) In particular, by forming the caulking portions on the scraps, the scraps can be connected with each other in the die, thereby preventing the springback and allowing large diameter thin plates to be stamped out.
(3) Furthermore, by forming the first and second narrow connecting portions together with the caulking portions on the scrap, springback prevention effect is further enhanced.

### BRIEF DESCRIPTION OF DRAWINGS

FIG. 1 is an explanatory diagram of a method for manufacturing a laminated iron core according to one embodiment of the present invention.

FIG. 2 is a partially enlarged view of a part “A” in FIG. 1.

FIG. 3 is an explanatory diagram of a method for manufacturing a laminated iron core according to another example of the present invention.

FIG. 4 is an explanatory diagram illustrating a method for manufacturing a stator core.

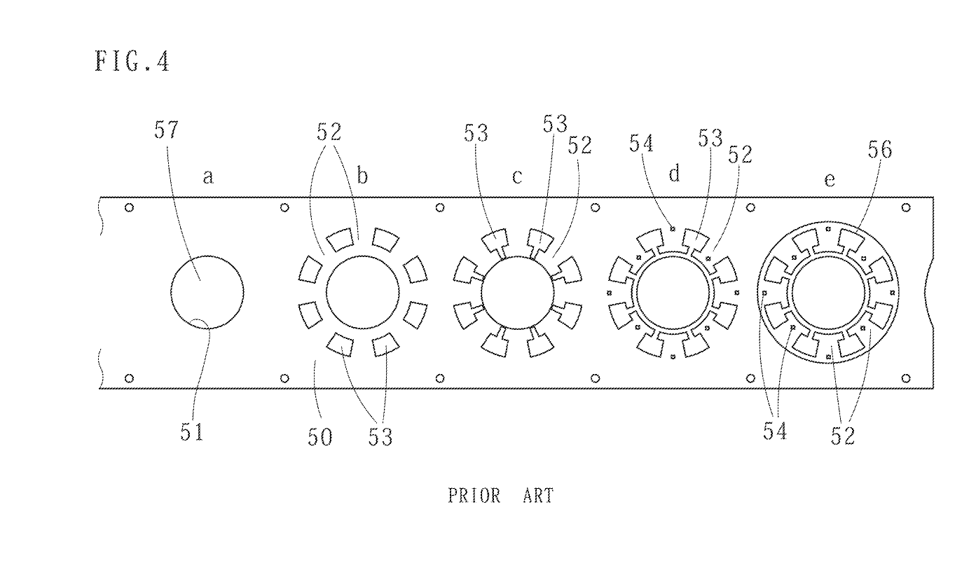

FIGS. 5(A) to 5(C) are explanatory diagrams of drawbacks of a method for manufacturing a laminated iron core according to a conventional example, respectively.

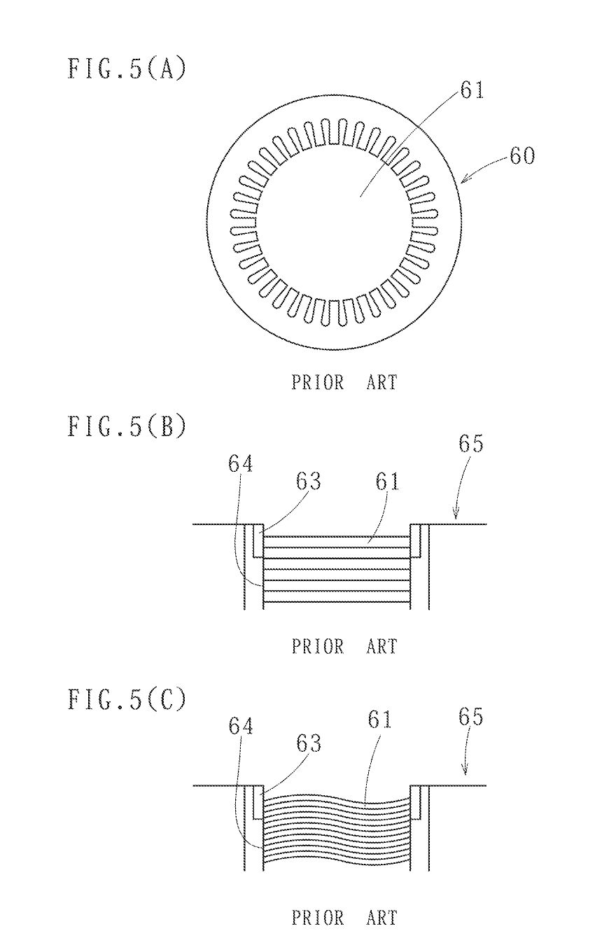

### DESCRIPTION OF EMBODIMENTS

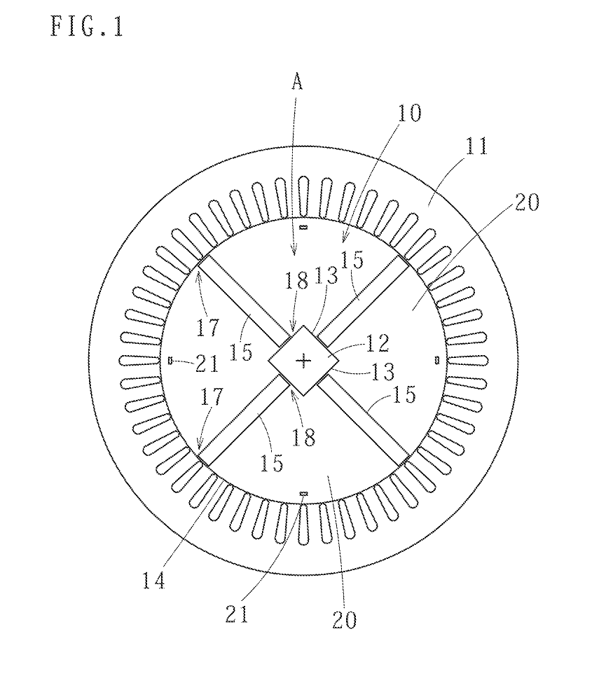

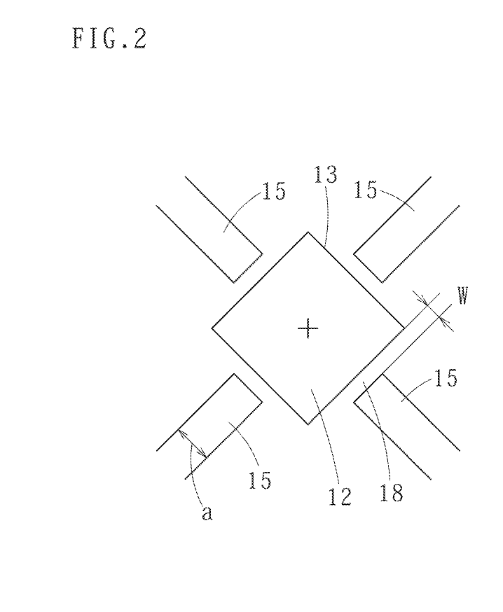

Next, a method for manufacturing a laminated iron core according to one embodiment of the present invention will be described hereunder with reference to the accompanying drawings. First, (the shape of) a scrap 10 illustrated in FIGS. 1 and 2 will be described.

As illustrated in FIG. 1, the scrap 10 is formed in a circular shape inside of a stator core piece 11 and has a square central hole 12 at a center thereof. Between sides 13 of the central hole 12 and a peripheral portion 14 of the scrap 10, four rectangular partition holes 15 are formed.

Adjacent partition holes 15 are disposed at an angle of 90 degrees with reference to the center of the scrap 10, and are formed axisymmetrically and radially (i.e., along a radial direction) centering around the central hole 12. Between one end of each of the partition holes 15 and the peripheral portion 14, a first narrow connecting portion 17 is formed, and between the opposite end of each of the partition holes 15 and the central hole 12, a second narrow connecting portion 18 is formed.

The scrap 10 in this embodiment has a diameter of 200 mm and a plate thickness of 0.25 mm, however, the present invention is applicable to a case where the diameter is 200 mm or more and the plate thickness is more than 0 mm but 0.3 mm or less. The length of a side (i.e., the side 13) of the square central hole 12 located at the center of the scrap 10 is appropriately between about 0.1 and 0.3 times the length of the diameter of the scrap 10, however, the present invention is not limited to these numbers.

A width “w” of the first and second narrow connecting portions 17 and 18 is preferably between 1 and 7 times the plate thickness of the scrap 10, more preferably between 3 and 5 times the plate thickness. Furthermore, the length of the first and second narrow connecting portions 17 and 18 is equal to a width “a” of the partition holes 15. The width “a” of the partition holes 15 is 3 times or more the length of width “w” of the first and second narrow connecting portions 17 and 18, and is preferably between about 3 and 10 times the length of width “w”. Still furthermore, although the number of the partition holes 15 in this embodiment is four, it is preferable that the number of the partition holes 15 be between 3 and 8 and the partition holes 15 be provided at equal angles. The first and second narrow connecting portions 17 and 18 function to absorb undulation and therefore prevent springback. If they are too narrow, they break by stress caused by stamping, while if they are too wide, they do not absorb stress due to lateral pressure of the die. Therefore, it is preferable that the width be set in the above-described range.

As illustrated in FIG. 1, areas 20 divided equally in a plural number by the partition holes 15 are each provided with a caulking portion 21 having a concave portion and a convex portion at front and back sides thereof, respectively. It is preferable that the caulking portions 21 be provided such that one each is in the middle of and at a radially outer side (i.e., in proximity to the peripheral portion 14) of each of the fan-shaped areas 20. Alternatively, a plurality of the caulking portions may be provided equally in each of the areas 20 so that a plurality of the scraps 10 can be stacked and fixed. The caulking portions 21 can be any of half-press caulking, V-shaped caulking, and the like.

Therefore, to manufacture the stator core pieces 11 using the scraps 10, pilot holes are formed in thin strip materials at proper pitches and the thin strip materials are successively conveyed to a die apparatus to form caulking portions 21, the central holes 12 and the partition holes 15 by press punching, and the scraps 10 are punched out. At this time, although stress is applied to the scraps 10, it is absorbed by the first and second narrow connecting portions 17, 18 and the partition holes 15, and thereby the scraps 10 are maintained in a planar state and scrap pulling does not occur. Subsequently, the stator core pieces 11 are formed by a usual process, and punched out and dropped into a die to manufacture a laminated iron core (motor core).

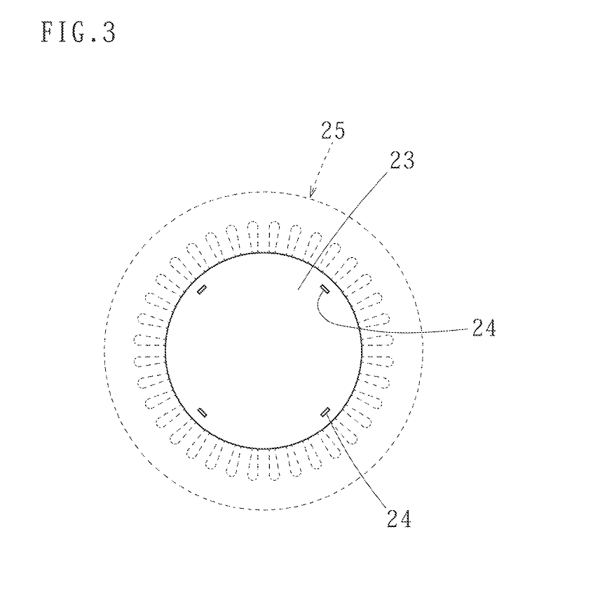

FIG. 3 illustrates another example where neither the central hole nor the partition holes are provided but only caulking portions 24 are formed on a scrap 23. The caulking portions 24 are formed at a plurality (preferably three or more) of locations equally spaced on the scrap 23. A stator core piece 25 and a manufacture of a laminated iron core using the stator core pieces 25 are the same as the above-described embodiment.

The caulking portions 24 alone can prevent scrap pulling and springback of the scrap 23, however, scrap pulling of the scrap 23 can be securely prevented by further forming the partition holes 15 each having the first and second narrow connecting portions 17 and 18 at opposite sides thereof, as in the scrap 10.

In the above-described embodiment, even when the central hole 12 was not formed, it was confirmed that there was an effect of preventing scrap pulling.

The present invention is not limited to the above-described embodiment and various changes may be made to the configuration (e.g., shapes and dimensions) without departing from the spirit and scope of the present invention.

### Industrial Applicability

The present invention prevents scrap pulling of scraps punched out during press work and realizes stable press work. Especially, the present invention contributes to stable press work operations when manufacturing large diameter thin plates.

### Reference Signs List

10: scrap, 11: stator core piece, 12: central hole, 13: side, 14: peripheral portion, 15: partition hole, 17: first narrow connecting portion, 18: second narrow connecting portion, 20: area, 21: caulking portion, 23, scrap, 24: caulking portion, 25: stator core piece

1-13. (canceled)

14. A method for manufacturing a laminated iron core by press punching a thin strip material to manufacture a motor core, the method comprising:
before punching out a scrap of an iron core piece for the motor core, forming a plurality of partition holes in the scrap to divide the scrap into a plurality of areas, each of the partition holes being connected at one end thereof with a peripheral portion of the scrap through a first narrow connecting portion.

15. The method for manufacturing a laminated iron core as defined in claim 14, further comprising forming a central hole at a central portion of the scrap, the central hole being connected with an opposite end of each of the partition holes through a second narrow connecting portion.

16. The method for manufacturing a laminated iron core as defined in claim 15, wherein the areas divided by the partition holes are provided with caulking portions for allowing a plurality of the scraps to be stacked and fixed.

17. The method for manufacturing a laminated iron core as defined in claim 15, wherein the scrap has a circular shape and the plurality of the partition holes are formed at equal angles along a radial direction of the scrap.

18. A shape of a scrap produced during manufacture of a motor core by press punching a thin strip material, comprising:
a plurality of partition holes for dividing the scrap into a plurality of areas, each of the partition holes being connected at one end thereof with a peripheral portion of the scrap through a first narrow connecting portion.

19. The shape of the scrap as defined in claim 18, wherein a central hole is formed at a central portion of the scrap, and an opposite end of each of the partition holes is connected with the central hole through a second narrow connecting portion.

20. The shape of the scrap as defined in claim 19, wherein the areas divided by the partition holes are provided with caulking portions for allowing a plurality of the scraps to be stacked and fixed.

21. The shape of the scrap as defined in claim 20, wherein the caulking portions are formed in proximity to the peripheral portion of the scrap.

22. The shape of the scrap as defined in claim 19, wherein the scrap has a circular shape with a diameter of 200 mm or more and a thickness of 0.3 mm or less.

23. The shape of the scrap as defined in claim 19, wherein the scrap is equally divided into the plurality of the areas by the partition holes.

24. The shape of the scrap as defined in claim 19, wherein the number of the partition holes is at least three.

25. The shape of the scrap as defined in claim 19, wherein a width of the first narrow connecting portions is between 1 and 7 times the thickness of a plate thickness of the scrap.

26. The shape of the scrap as defined in claim 19, wherein a width of the partition holes is 3 times or more the width of the first narrow connecting portions.
